(19) United States
(12) Patent Application Publication
(10) Pub. No.: US 2010/0026428 A1
(43) Pub. Date: Feb. 4, 2010

(54) Power Control Device and Methods

(76) Inventor: Gus Cueto, Atlanta, GA (US)

Correspondence Address: Ballard Spahr LLP, SUITE 1000, 999 PEACHTREE STREET, ATLANTA, GA, 30309-3915, US

(21) Appl. No.: 12/512,663

(22) Filed: Jul. 30, 2009

Related U.S. Application Data
(60) Provisional application No. 61/086,049, filed on Aug. 4, 2008.

(51) Int. Cl. H01H 9/20; H01H 47/00

(52) U.S. Cl. 335/167; 361/143

(57) ABSTRACT

A power control apparatus comprising at least a coil, a contact and a manual control used to continuously energize a load when the contact is in the closed position and to de-energize the load when the contact is open. The apparatus consumes no energy while maintaining the closed or open state of the contact. Methods of operation are also described. In one aspect, the power control apparatus is embodied in the form of a standard, wall-mounted light switch.

### CROSS REFERENCE TO RELATED APPLICATION

This application claims benefit of and priority to U.S. Provisional Patent Application No. 61/086,049, filed Aug. 4, 2008, which application is fully incorporated herein by reference in its entirety and made a part hereof.

### FIELD

Embodiments described herein relate to power control devices and, in particular to a lighting control switch.

### BACKGROUND

Currently in the lighting control market, there are no inexpensive, reliable lighting control options, a challenge that is most notably prevalent for a non-industrial application. While the marketplace offers systems with sophisticated microprocessor controlled devices that communicate over a hardwired or RF communication bus using proprietary protocols, what is needed is a reliable, inexpensive and adaptable power control device that overcomes many of the challenges found in the art, some of which are described above.

### SUMMARY

Described herein are methods, systems, and apparatuses for power control. In one aspect, provided are power control apparatuses, comprising: a plurality of coils; at least one relay contact, associated with said plurality of coils. The relay contact, associated with a first coil, is closed upon the first coil receiving a first remote signal. The relay contact, also associated with a second coil, is opened upon the second coil receiving a second remote signal. The apparatus further comprises a local manual control that is mechanically coupled to the relay contact. The local manual control is configured to mechanically close the relay contact and to mechanically open the relay contact. The relay contact is configured for continuously energizing a load, upon closing the at least one relay contact, either by the first coil receiving the first remote signal or mechanically by the local manual control, and for de-energizing the load, upon opening the at least one relay contact, either by the second coil receiving the second remote signal or mechanically by the local manual control.

In another aspect, the power control apparatus is embodied in the form of a standard, wall-mounted light switch.

In yet another aspect, methods for power control are described herein. The methods can comprise providing a power control apparatus. The power control apparatus is comprised of a relay contact, a first coil and a second coil associated with the relay contact, and a local manual control. The relay contact of the power control apparatus is configured to close upon the first coil associated with the relay contact receiving a first remote signal. The relay contact of the power control apparatus is configured to open upon the second coil associated with the relay contact receiving a second remote signal. The local manual control is mechanically coupled to the relay contact, wherein the local manual control is configured to be operated manually, in order to mechanically close the relay contact and to mechanically open the relay contact. The power control apparatus is configured for continuously energizing a load, upon closing the relay contact, either by the first coil receiving the first remote signal or mechanically, by operating the local manual control, and for de-energizing the load, upon opening the relay contact, either by the second coil receiving the second remote signal or mechanically, by operating the local manual control.

In another aspect, provided are methods, systems, and apparatuses for remote power control as described above, wherein the local manual control is a manual switch, wherein the manual switch is mechanically coupled to the at least one relay contact, such that applying pressure to the manual switch in a first direction mechanically closes the at least one relay contact, thereby energizing the load, and such that applying pressure to the manual switch in a second direction mechanically opens the at least one relay contact, thereby de-energizing the load. In one aspect, the switch is spring-loaded, such that it returns to an inactive position once pressure is released. In another aspect, the power control apparatus is embodied in the form of a standard, wall-mounted light switch.

Additional advantages will be set forth in part in the description that follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary apparatus for power control;

FIG. 2 is an exemplary method of operation an apparatus for power control;

FIG. 3 is another two-wire embodiment of a power control apparatus comprising a relay contact associated with a single coil;

FIG. 4 is a flowchart illustrating a method of power control using a device such as the one shown in FIG. 3;

FIG. 5A is a three-wire embodiment of a power control apparatus having more than one coil for operation of the relay contact, similar to the apparatus shown in FIG. 1; and

FIG. 5B is a three-wire embodiment of a power control apparatus having one coil, similar to the apparatus shown in FIG. 3.

### DETAILED DESCRIPTION

Before the present methods and systems are disclosed and described, it is to be understood that the apparatuses, methods and systems are not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents, unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. Further, the phrase “such as” as used herein is not intended to be restrictive in any sense, but is merely explanatory and is used to indicate that the recited items are just examples of what is covered by that provision.

Disclosed are components that can be used to perform the disclosed methods, apparatuses and systems. These and other components are disclosed herein, and it is understood that when combinations, subsets, interactions, groups, etc. of these components are disclosed that, while specific reference of each various individual and collective combinations and permutation of these may not be explicitly disclosed, each is specifically contemplated and described herein, for all methods, apparatuses and systems. This applies to all aspects of this application including, but not limited to, steps in disclosed methods. Thus, if there are a variety of additional steps that can be performed, it is understood that each of these additional steps can be performed with any specific embodiment or combination of embodiments of the disclosed methods.

The present methods, systems, and apparatuses may be understood more readily by reference to the following detailed description of preferred embodiments and the Examples included therein and to the Figures and their previous and following description.

The method, systems, and apparatuses disclosed herein comprise relays. Since relays are switches, the terminology applied to switches can also be applied to relays. A relay can switch one or more poles, each of whose contacts can be thrown by energizing the coil in one of three ways: Normally-open (NO) contacts connect the circuit when the relay is activated, the circuit is disconnected when the relay is inactive (also referred to as a Form A contact or “make” contact); Normally-closed (NC) contacts disconnect the circuit when the relay is activated, the circuit is connected when the relay is inactive (also referred to as a Form B contact or “break” contact); Change-over, or double-throw, contacts control two circuits, one normally-open contact and one normally-closed contact with a common terminal (also referred to as a a Form C contact or “transfer” contact. If this type of contact utilizes a “make before break” functionality, then it is called a Form D contact).

A Single Pole Double Throw (SPDT) is a terminal that can connect to either of two others terminals. Including two for the coil, such a relay can have five terminals in total. A Double Pole Double Throw (DPDT) is a terminal comprising two rows of change-over terminals. Equivalent to two SPDT switches or relays actuated by a single coil. Such a relay can have eight terminals, including the coil.

Examples of relays include, but are not limited to, latching relays, reed relays, mercury-wetted reed relays, polarized relays, machine tool relays, contactor relays, solid state contactor relays, Buchholz relays, forced-guided contacts relays, solid state relays, and overload protection relays. By way of example and not meant to be limiting, the present methods, systems, and apparatuses are described herein using latching relays. However, it is specifically contemplated that other types of relays can be used without departing from the scope of the methods, systems, and apparatuses described herein. A latching relay can have two relaxed states (bistable). These can be referred to as “keep” relays. When the current is switched off, the relay remains in its last state. This can be achieved with a solenoid operating a ratchet and cam mechanism, or by having two opposing coils with an over-center spring or permanent magnet to hold the armature and contacts in position while the coil is relaxed, or with a remnant core. In the two coil example, a pulse to one coil turns the relay on and a pulse to the opposite coil turns the relay off. This type of relay can consume power only for an instant, while it is being switched, and retain its last setting across a power outage.

In one aspect, provided is a relay-controlled light switch, comprising a plurality of power inputs, configured for turning a power load ON and OFF, and a dry contact feedback, to indicate if the load is ON.

In an aspect, provided are apparatuses for use in a “two-wire” installation. The “two-wire” apparatus is configured to use a hot (energized) and return switch legs, available at the switch. This type of wiring is typically found in commercial installations. A “three-wire” apparatus can be configured to use a hot, neutral (not switched) and return switch legs, available at the switch.

In an aspect, provided is a two-wire power switch with low voltage remote actuation control using one or more latching relays such as for example a 24 VDC latching relay as are known in the art, though latching relays of various voltage and current ratings are contemplated within the scope of embodiments of the invention. The power switch can be remotely controlled by voltage pulses such as for example 12 VDC, 24 VDC, 48 VDC, etc., and locally controlled by a manual switch. The power switch can be used to remotely control lights, motors and any other electrically powered system. The power switch can interface with any automation system. The power switch can comprise a mechanically latching power relay with one or more coils such as, for example, two coils. In one instance for a relay having two coils, a low voltage pulse to either of the relay coils that has not been activated can cause a change of state to the mechanically latching power relay, causing power to be applied, or discontinued, to the attached electrical device. In another instance, a relay can be associated with only one coil. Applying a voltage pulse to the coil can change the state of the relay (i.e., if the relay is closed, applying the voltage pulse will cause it to open and stay open; alternatively, if the relay is open, applying the voltage pulse will cause the relay to close and stay closed). The manual switch can also be used to control power to the load. Applying pressure to the manual switch in a first direction such as, for example an upward direction, can cause the circuit to change to the ON state and applying pressure to the manual switch in a second direction such as, for example, a downward direction, can cause the circuit to change to the OFF state. The power switch can comprise an interlocking circuit that can prevent simultaneous ON-OFF signals from damaging the relay, thus increasing switch life and reliability.

In an aspect, provided is an electrical power control device, comprising means to be remotely controlled by low voltage pulses. The device can comprise means to be actuated to a known state of open or closed circuit by a remote low voltage pulse. The device can comprise an interlocking circuit such that, if the relay has more than one coil and a simultaneous pulse to both the open and close circuit is received, one pulse can be ignored preventing the control circuit from being damaged. The device can also comprise a local, mechanically interlocked switch that can allow local control of the circuit. This switch can be mechanically interlocked, such that the ON and OFF positions cannot be achieved simultaneously. Said device can be used to control lights, motors or any other electrically powered device, or combination of devices.

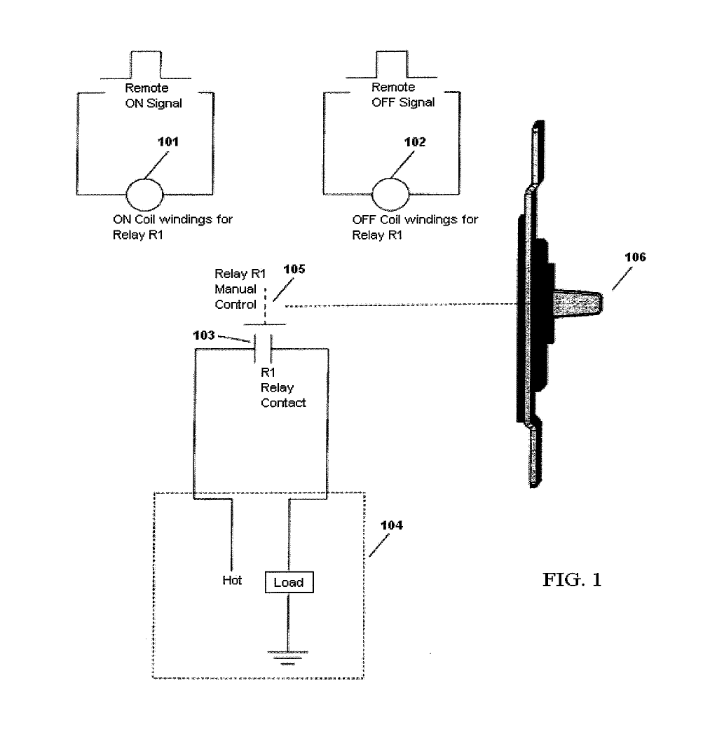

In one aspect, illustrated in FIG. 1 is a two-wire embodiment of a power control apparatus 100. To remotely turn ON said apparatus, a first voltage pulse such as, for example, a 12 VDC pulse, a 24 VDC pulse, a 48 VDC pulse, etc., can be applied to the ON Coil windings 101 for Relay R1 102. The voltage and current rating of the ON coil windings 101 can be selected depending upon the source of the first voltage pulse. Energization of the ON coil winding 101 by the first voltage pulse can close Relay R1's contact 103, thus completing the circuit and energizing the load within the dashed box 104. The load within the dashed box 104 can be any type of load, such as a light, a motor or any other device, or combination of devices, that is within the voltage and current specifications of the apparatus. Because Relay R1 is a mechanically latching relay, it can remain in this position when the pulse is removed from the ON Coil windings for Relay R1 101, thereby not requiring constant energization and power loss.

To remotely turn OFF said apparatus 100, a second voltage pulse such as, for example, a 12 VDC pulse, a 24 VDC pulse, a 48 VDC pulse, etc., can be applied to the OFF Coil windings for Relay R1 102. This can open Relay R1's contact 103, thus de-energizing the load within the dashed box 104. The load within the dashed box 104 can be any type load, such as a light, a motor or any other device, or combination of devices, that is within the voltage and current specifications of the apparatus. Because Relay R1 is a mechanically latching relay, it can remain in this position when the pulse is removed from the OFF Coil windings for Relay R1 102 thereby not requiring constant energization and power loss.

Because of the use of a mechanical latching relay, coils associated with the relay R1 do not require constant energization. Thus, the device 100 does not consume energy while in the ON state or the OFF state.

To locally turn ON said apparatus, pressure can be applied in a first direction such as, for example, an upward direction, to a manual switch 106, mechanically coupled to Relay R1's contact 103 via the manual control 105, thereby causing Relay R1's contact 103 to close, thus energizing the load within the dashed box 104. The load within the dashed box (104) can be any type load, such as a light, a motor or any other device, or combination of devices, that is within the voltage and current specifications of the apparatus. Though not confined to this form, in one aspect the power control apparatus 100 can be embodied in the form of a standard, wall-mounted light switch.

To locally turn OFF said apparatus 100, pressure can be applied in a second direction such as, for example, a downward direction, to the manual switch 106, thereby causing Relay R1's contact 103 to open, thus de-energizing the load within the dashed box 104. The load within the dashed box 104 can be any type load, such as a light, a motor or any other device, or combination of devices, that is within the voltage and current specifications of the apparatus.

Control signals can be sent to the apparatus from many devices. Examples include, but are not limited to, a building security system, a simple push button, a Building Automation System (BAS) or an occupancy sensor. A security system can send a pulse to turn OFF all the lights when the building is vacated or turn ON all the lights when a burglary is detected or the building becomes occupied. A simple push button can be used to allow convenient control of lights from one or more locations without expensive electrical rewiring. Occupancy sensors can be used to send control signals to the apparatus to shut down lights when a building space is unoccupied. More sophisticated BAS systems can also interface with the apparatus allowing advanced energy management by controlling lights.

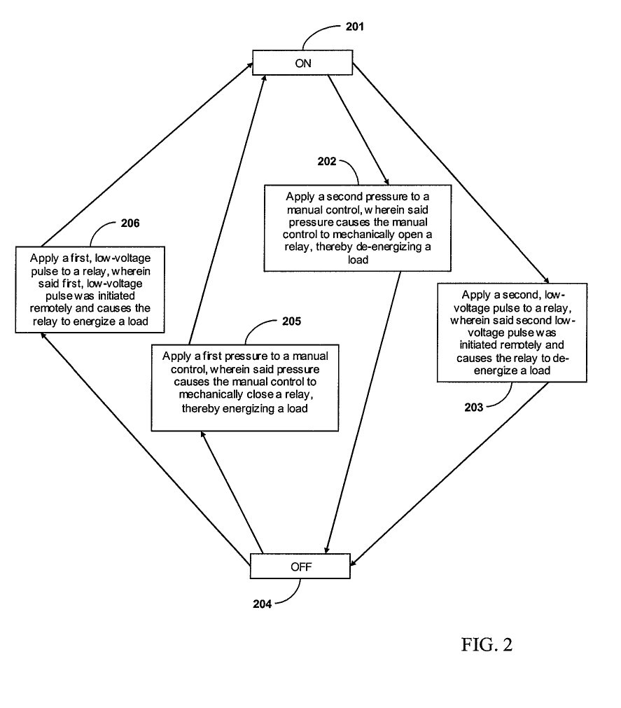

In another aspect, illustrated in FIG. 2, provided are methods for power control, comprising applying a first, low-voltage pulse such as, for example, a 12 VDC pulse, a 24 VDC pulse, a 48 VDC pulse, etc., to a first coil associated with a relay contact, wherein the first, low-voltage pulse can be initiated remotely. The first pulse, applied to the first coil, causes the relay contact to change from an OPEN state to a CLOSED state, thereby causing the relay to energize a load at 206. A second, low-voltage pulse such as, for example, a 12 VDC pulse, a 24 VDC pulse, a 48 VDC pulse, etc., applied to a second coil associated with the relay contact, causes the relay contact to change from a CLOSED state to an OPEN state. The second, low-voltage pulse can be initiated remotely and causes the relay to OPEN, thus de-energizing a load at 203. The relay contact can also be controlled locally by a mechanically-operated switch. For example, applying a first pressure to a manual control, wherein the pressure causes the manual control to mechanically close a relay (assuming it was open to begin with), thereby energizing a load at 205. Applying a second pressure to the manual control causes the manual control to mechanically open a relay (assuming it was closed), thereby de-energizing a load at 202.

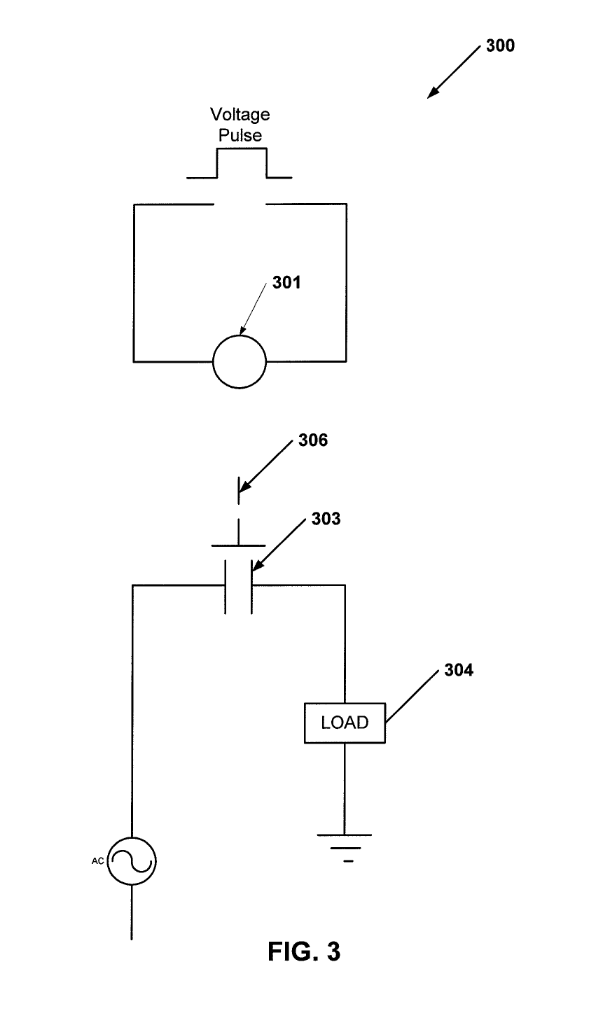

Illustrated in FIG. 3 is another two-wire embodiment of a power control apparatus 300 comprising a relay contact 303 associated with a single coil 301. To remotely turn ON said apparatus, where ON means to close the contact 303, a first voltage pulse such as, for example, a 12 VDC pulse, a 24 VDC pulse, a 48 VDC pulse, etc., can be applied to the coil windings 301 for Relay R1. The voltage and current rating of the coil windings 301 can be selected depending upon the source of the first voltage pulse. Energization of the coil winding 301 by the first voltage pulse can close Relay R1's contact 303, thus completing the circuit and energizing the load 304. The load 304 can be any type of load, such as a light, a motor or any other device, or combination of devices, that is within the voltage and current specifications of the apparatus. Because Relay R1 is a mechanically latching relay, it can remain in this position when the pulse is removed from the coil windings for Relay R1 301, thereby not requiring constant energization and avoiding power loss.

To remotely turn OFF said apparatus 300, a second voltage pulse such as, for example, a 12 VDC pulse, a 24 VDC pulse, a 48 VDC pulse, etc., can be applied to the coil windings 301 for Relay R1. Energization of the coil windings 301 by the voltage pulse can open Relay R1's contact 303, thus de-energizing the load 304. The load 304 can be any type load, such as a light, a motor or any other device, or combination of devices, that is within the voltage and current specifications of the apparatus. Because Relay R1 is a mechanically latching relay, it can remain in this position when the pulse is removed from the coil windings 301 for Relay R1 thereby not requiring constant energization and avoiding power loss.

Because of the use of a mechanical latching relay, the coil associated with the relay R1 does not require constant energization. Thus, the device 300 does not consume energy while in the ON state or the OFF state.

To locally turn ON said apparatus 300, pressure can be applied in a first direction such as, for example, an upward direction, to a manual switch 306, mechanically coupled to Relay R1's contact 303 via the manual control 306, thereby causing Relay R1's contact 303 to close, thus energizing the load 304. The load 304 can be any type load, such as a light, a motor or any other device, or combination of devices, that is within the voltage and current specifications of the apparatus. Though not confined to this form, in one aspect the power control apparatus 300 can be embodied in the form of a standard, wall-mounted light switch.

To locally turn OFF said apparatus 300, pressure can be applied in a second direction such as, for example, a downward direction, to the manual switch 306, thereby causing Relay R1's contact 303 to open, thus de-energizing the load 304. The load 304 can be any type load, such as a light, a motor or any other device, or combination of devices, that is within the voltage and current specifications of the apparatus. Also provided are methods for power control, comprising applying a low-voltage pulse such as, for example, a 12 VDC pulse, a 24 VDC pulse, a 48 VDC pulse, etc., to a coil associated with a relay contact, wherein the first, low-voltage pulse can be initiated remotely. If the relay is currently in an OPEN state, then the first pulse, applied to the coil, causes the relay contact to change from an OPEN state to a CLOSED state, thereby causing the relay to energize a load. If the relay is currently in a CLOSED state, then the pulse, applied to the coil, causes the relay contact to change from a CLOSED state to an OPEN state, thereby causing the relay to de-energize the load. The relay contact can also be controlled locally by a mechanically-operated switch. For example, applying a first pressure to a manual control, wherein the pressure causes the manual control to mechanically close or open the relay contact, thereby energizing or de-energizing a load. For example, if the relay is currently in a CLOSED state, then the pressure applied to the manual control causes the relay contact to change from a CLOSED state to an OPEN state, thereby causing the relay to de-energize the load. If the relay is currently in an OPEN state, then the pressure applied to the manual control causes the relay contact to change from an OPEN state to a CLOSED state, thereby causing the relay to energize the load.

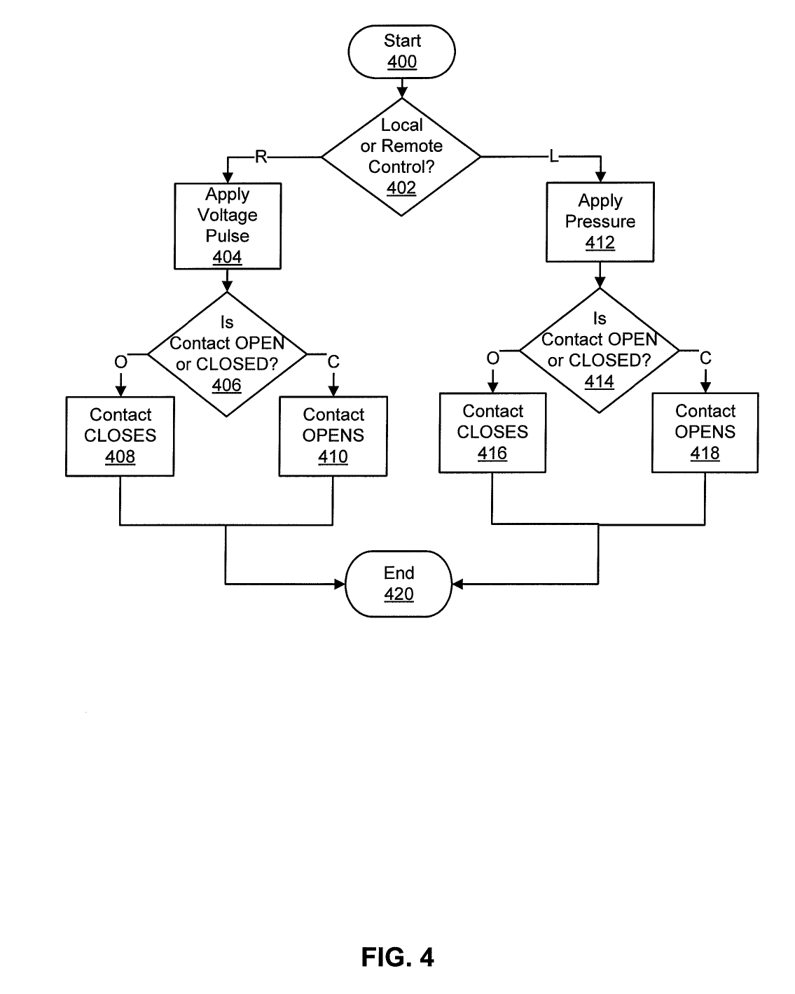

FIG. 4 provides a flowchart illustrating a method of power control using a device 300 such as the one shown in FIG. 3. The process starts at step 400. At step 402, it is determined whether the power control device 300 is to be controlled locally or remotely. If remotely, then the process goes to step 404, where a voltage pulse is applied to the coil windings 301. At step 406, it is determined whether the relay contact 303 is in an OPEN state or a CLOSED state. If in an OPEN state, then at step 408 the voltage pulse applied to the coil windings 301 causes the relay contact 303 to CLOSE. If, at step 406 it is determined that the relay contact is in a CLOSED state, then at step 410 the voltage pulse applied to the coil windings 301 causes the relay contact 303 to OPEN. Returning to step 402, if it is determined that the power control device 300 is to be controlled locally, at step 412 pressure is applied to a manual control associated with the power control device 300. At step 414, it is determined whether the relay contact 303 is in an OPEN state or a CLOSED state. If in an OPEN state, then at step 416 the pressure applied to the manual control causes the relay contact 303 to CLOSE. If, at step 414 it is determined that the relay contact is in a CLOSED state, then at step 418 the pressure applied to the manual control causes the relay contact 303 to OPEN. The process ends at step 420.

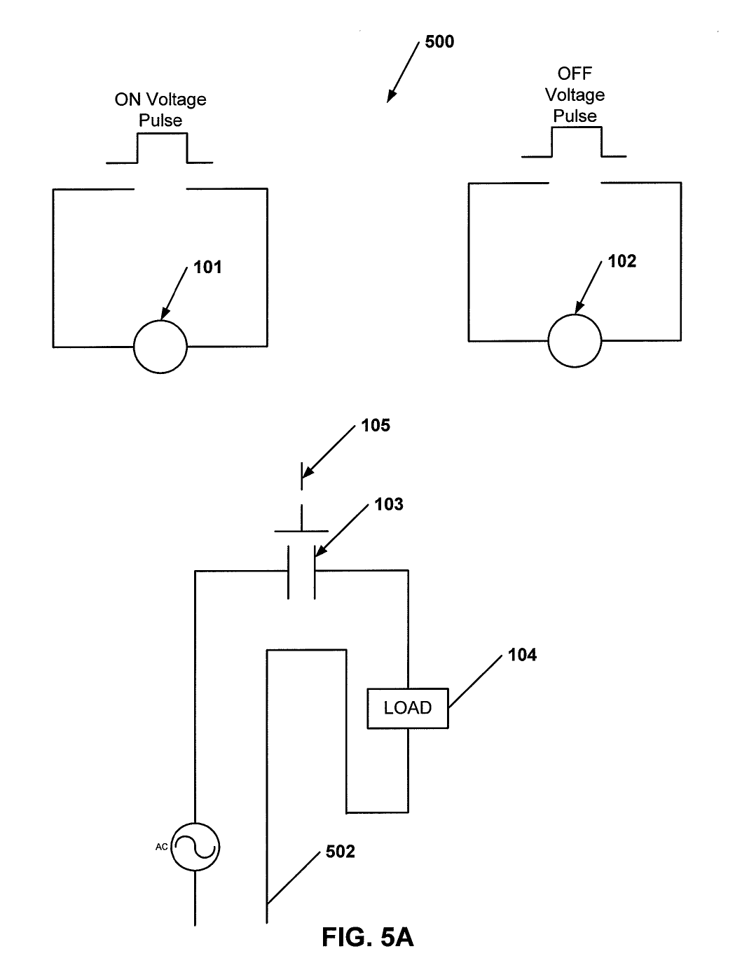

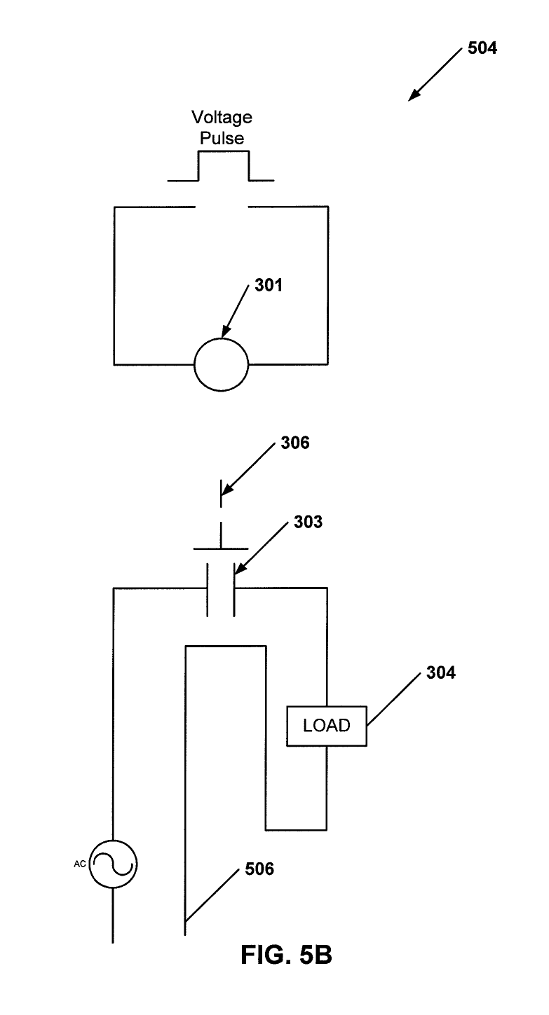

In one aspect, illustrated in FIG. 5A is a three-wire embodiment of a power control apparatus 500 having more than one coil for operation of the relay contact 503, similar to the apparatus shown in FIG. 1. This embodiment comprises the neutral wire 502. This embodiment operates in the manner described in relation to FIGS. 1 and 2, as described above.

In another aspect, illustrated in FIG. 5B is a three-wire embodiment of a power control apparatus 504 having one coil, similar to the apparatus shown in FIG. 3. This embodiment comprises the neutral wire 506. This embodiment operates in the manner described in relation to FIGS. 3 and 4, as described above.

While the methods, systems, and apparatuses have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method, set forth herein, be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A power control apparatus, comprising:
a first coil;
at least one relay contact, associated with said first coil, wherein the at least one relay contact is in a first state and is changed from said first state to a second state upon said first coil receiving a first voltage pulse and the at least one relay contact is changed from said second state to said first state upon said first coil receiving a second voltage pulse; and
a local manual control, mechanically coupled to the at least one relay contact, wherein the local manual control is configured to change the state of said relay from said first state to said second state or from said second state to said first state;
wherein said at least one relay contact remains in said second state after said first coil receives said first voltage pulse until said first coil receives said second voltage pulse or until said local manual control is used to change said at least one relay contact from said second state to said first state and said first coil is not constantly energized while said at least one relay contact is in said first state or in said second state.

2. The power control device of claims 1, wherein said first state is OPEN and said second state is CLOSED.

3. The power control device of claim 1, further comprising a second coil, wherein the at least one relay contact is associated with the first coil and the second coil, and said at least one relay contact is changed from the first state to the second state upon said first coil receiving the first voltage pulse and the at least one relay contact is changed from said second state to said first state upon said second coil receiving said second voltage pulse.

4. The power control apparatus of claim 1, wherein the local manual control is a manual switch, mechanically coupled to the at least one relay contact, such that applying pressure to the manual switch in a first direction mechanically closes the at least one relay contact, thereby energizing a load, and such that applying pressure to the manual switch in a second direction mechanically opens the at least one relay contact, thereby de-energizing the load.

5. The power control apparatus of inventive concept 3, further comprising:
a spring-loaded mechanism that returns the manual switch to an inactive position once pressure is released from said manual switch.

6. The power control apparatus of claim 1, wherein said power control device is embodied in the form of a standard, wall-mounted light switch.

7. The power control device of claim 1, wherein said first voltage pulse is 24 VDC.

8. The power control device of claim 1, wherein said second voltage pulse is 24 VDC.

9. A power control apparatus, comprising:
a plurality of coils;
at least one relay contact associated with said plurality of coils, wherein the at least one relay contact, associated with a first coil, is closed upon said first coil receiving a first remote signal and the at least one relay contact, associated with a second coil, is opened upon said second coil receiving a second remote signal; and
a local manual control mechanically coupled to the at least one relay contact, wherein the local manual control is configured to mechanically close the at least one relay contact and to mechanically open the at least one relay contact;
wherein the at least one relay contact is configured for continuously energizing a load upon closing the at least one relay contact, either by the first coil receiving the first remote signal or mechanically by the local manual control, and for de-energizing the load upon opening the at least one relay contact, either by the second coil receiving the second remote signal or mechanically by the local manual control; and
wherein said at least one power control apparatus consumes energy only while said at least one relay contact is changing from open to closed or from closed to open.

10. The power control apparatus of claim 9, wherein the local manual control is a manual switch, mechanically coupled to the at least one relay contact, such that applying pressure to the manual switch in a first direction mechanically closes the at least one relay contact, thereby energizing the load, and such that applying pressure to the manual switch in a second direction mechanically opens the at least one relay contact, thereby de-energizing the load.

11. The power control apparatus of claim 9, further comprising:
a spring-loaded mechanism that returns the manual switch to an inactive position once pressure is released from the manual switch.

12. The power control apparatus of claim 9, wherein the power control apparatus is embodied in the form of a standard, wall-mounted light switch.

13. A method for power control, comprising:
receiving a first state-changing input at a power control device;
changing the state of a relay contact associated with the power control device from a first state to a second state subsequent to receiving the first state changing input;
removing the state changing input;
maintaining the second state of the relay contact until a second state-changing input is received at the power control device, wherein the second state-changing input changes the state of the relay contact associated with the power control device from the second state to the first state,
wherein said power control device requires energy for operation only while changing said relay contact associated with said power control device from said first state to said second state or from said second state to said first state.

14. The method of claim 13, wherein receiving the first state-changing input at the power control device comprises receiving a voltage pulse at a first coil associated with the power control device and the relay contact.

15. The method of claim 13, wherein receiving the first state-changing input at the power control device comprises receiving a mechanical input at a local manual control that is mechanically coupled to the relay contact associated with the power control device.

16. The method of claim 13, wherein receiving the second state-changing input at the power control device comprises receiving a voltage pulse at a first coil associated with the power control device and the relay contact.

17. The method of claim 13, wherein receiving the second state-changing input at the power control device comprises receiving a mechanical input at a local manual control that is mechanically coupled to the relay contact associated with the power control device.

18. The method of claim 13, wherein receiving the first state-changing input at the power control device comprises receiving a voltage pulse at a second coil associated with the power control device and the relay contact.

19. The method of claim 13, wherein receiving the second state-changing input at the power control device comprises receiving a voltage pulse at a second coil associated with the power control device and the relay contact.

20. The method of claim 13, wherein changing the state of the relay contact associated with the power control device from the first state to the second state subsequent to receiving the first state changing input comprises changing the relay contact from an open state to a closed state.

21. The method of claim 21, wherein said power control device continuously energizes a load when said relay contact is in the closed state.

22. The method of claim 13, wherein changing the state of the relay contact associated with the power control device from the first state to the second state subsequent to receiving the first state changing input comprises changing the relay contact from a closed state to an open state.

23. The method of claim 22, wherein said power control device de-energizes a load when said relay contact changes from the closed state to the open state.

24. The method of claim 13, wherein changing the state of the relay contact associated with the power control device from the second state to the first state subsequent to receiving the second state changing input comprises changing the relay contact from an open state to a closed state.

25. The method of claim 24, wherein said power control device continuously energizes a load when said relay contact is in the closed state.

26. The method of claim 13, wherein changing the state of the relay contact associated with the power control device from the second state to the first state subsequent to receiving the second state changing input comprises changing the relay contact from a closed state to an open state.

27. The method of claim 26, wherein said power control device de-energizes a load when said relay contact changes from the closed state to the open state.
